(19) United States
(12) Patent Application Publication
(10) Pub. No.: US 2007/0050364 A1
(43) Pub. Date: Mar. 1, 2007

(54) System, method, and software for implementing business rules in an entity

(76) Inventor: Fred A. Cummins, Farmington Hills, MI (US)

Correspondence Address: BAKER BOTTS L.L.P., 2001 ROSS AVENUE, 6TH FLOOR, DALLAS, TX, 75201, US

(21) Appl. No.: 11/219,031

(22) Filed: Sep. 1, 2005

(51) Int. Cl. G06F 17/30

(52) U.S. Cl. 707/9

(57) ABSTRACT

In certain embodiments, a method for implementing one or more business rules in an entity includes receiving a database operation corresponding to one or more database components of one or more operational databases and invoking, in response to receiving the database operation, a rule evaluation service. The rule evaluation service is operable to (1) determine one or more appropriate business rules to evaluate based on the database operation; (2) evaluate the one or more appropriate business rules to determine whether allowing the database operation to be performed will violate any of the one or more business rules; and (3) determine, if it is determined that allowing the database operation to be performed will violate one or more of the evaluated business rules, an appropriate action to initiate for handling the determined violation.

### TECHNICAL FIELD OF THE INVENTION

This invention relates generally to business management and more particularly to a system, method, and software for implementing business rules in an entity.

### BACKGROUND

Business enterprises or other suitable entities often employ a number of business rules in the operation of their businesses. As examples, some business rules may help ensure that the enterprise is employing best or good business practices, some business rules may ensure accountability and control, some business rules may help ensure quality or timeliness, and some business rules may help minimize or prevent risk or loss. As another example, some business rules may help ensure that an enterprise is complying with one or more government regulations. A business rule may apply at a variety of places in operation of an enterprise. Additionally, business rules may be incorporated into an enterprise in a variety of ways. For example, business rules may be implemented through human actions directed by instructions or orders (e.g., employee compliance with a manager's instructions). As another example, business rules may be implemented by decisions incorporated into business processes. As another example, business rules may be implemented by computer applications in input edits or business logic, with the business rules being hard-coded into the computer applications. As yet another example, business rules may be implemented through reviews of proposals and/or through inspections.

### SUMMARY OF THE INVENTION

According to the present invention, disadvantages and problems associated with previous techniques for implementing business rules in an entity may be reduced or eliminated.

In certain embodiments, a method for implementing one or more business rules in an entity includes receiving a database operation corresponding to one or more database components of one or more operational databases and invoking, in response to receiving the database operation, a rule evaluation service. The rule evaluation service is operable to (1) determine one or more appropriate business rules to evaluate based on the database operation; (2) evaluate the one or more appropriate business rules to determine whether allowing the database operation to be performed will violate any of the one or more business rules; and (3) determine, if it is determined that allowing the database operation to be performed will violate one or more of the evaluated business rules, an appropriate action to initiate for handling the determined violation.

Particular embodiments of the present invention may provide one or more technical advantages. Previous and existing techniques for implementing business rules often involve embedding the business rules in computer applications or other business processes of an entity. In some cases, business rules may be simply by word-of-mouth or verbal instructions from managers or other individuals. These and other techniques may make deploying, monitoring, executing, modifying, and/or removing business rules difficult, if possible at all.

In certain embodiments, the present invention may enable consistent application of business rules throughout an enterprise. In certain embodiments, the present invention allows business rules to be transformed from a high level rule describing the bounds of acceptable operation of the enterprise to business rules that may be evaluated with respect to changes in one or more operational databases. In certain embodiments, the present invention uses a virtual database schema for one or more operational databases to create a stored procedure for one or more business rules that may be executed in response to database operations to initiate evaluation of the one or more business rules and to raise an exception if it is determined that allowing the database operation to be performed will violate one or more of the business rules.

Certain rule processing logic may be generally independent of affected computer applications. In certain embodiments, the present invention provides a mechanism for monitoring violations of business rules such as the generation of an event when a violation is detected. In certain embodiments, certain rule processing may be substantially separate from one or more applications, and the one or more applications may determine the consequences of violating a business rule. In certain embodiments, the present invention provides a mechanism, which in certain embodiments may be automated, for pervasively deploying, executing, monitoring, modifying, and removing business rules. The present invention may enable managers or other suitable individuals or computer applications to deploy, execute, monitor, modify, and remove business rules and be assured that the impact of such changes will be effected promptly, consistently, and pervasively throughout an enterprise, if appropriate. The present invention may help entities such as business enterprises by providing agility and assisting in compliance with government regulations. The present invention may enable application of business rules to legacy applications as well as new applications, so that business rules can be implemented throughout the enterprise with minimal impact on existing applications.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example system for implementing one or more business rules in an entity;

FIG. 2 illustrates an example method for deploying a business rule according to certain embodiments of the present invention;

FIG. 3 illustrates an example method for removing a business rule according to certain embodiments of the present invention; and

FIG. 4 illustrates an example method for executing one or more business rules according to certain embodiments of the present invention.

### DESCRIPTION OF EXAMPLE EMBODIMENTS

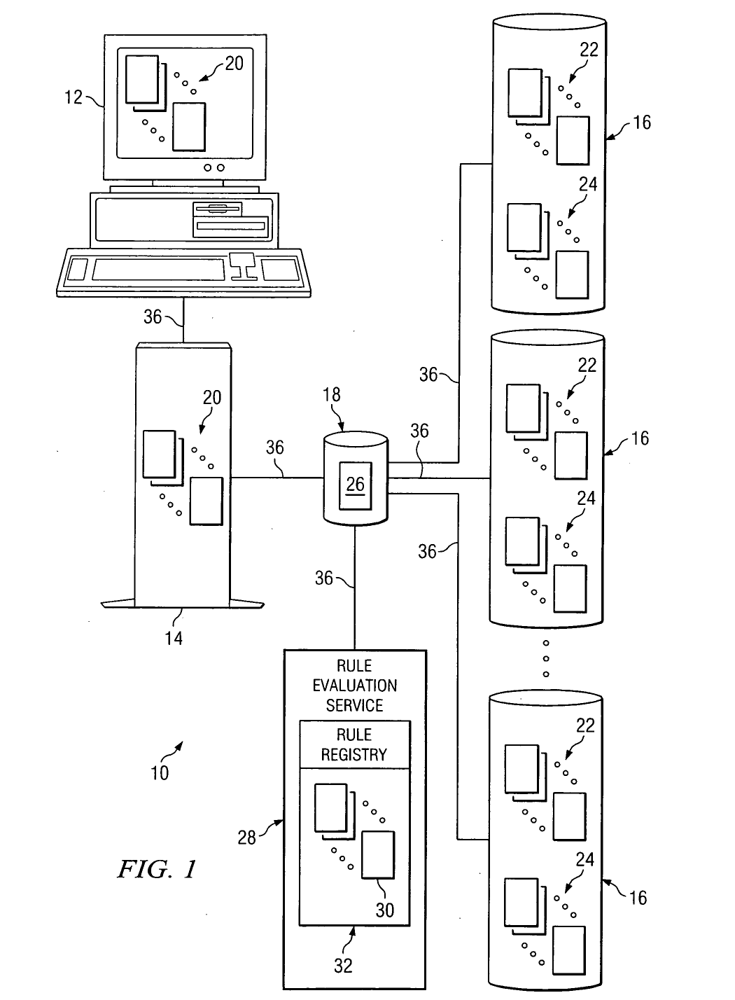

FIG. 1 illustrates an example system 10 for implementing one or more business rules in an entity. In certain embodiments, system 10 includes one or more one or more user systems 12, a server system 14, one or more operational databases 16, and a virtual database schema 18. Although an example implementation of system 10 is illustrated and primarily described, the present invention contemplates any suitable implementation of system 10.

System 10 or portions of system 10 may be associated with an entity such as a business enterprise. Throughout the remainder of this description, the entity associated with system 10 (or portions of system 10) will be referred to as an enterprise; however, it should be understood that system 10 (or portions of system 10) may be associated with any suitable entity, according to particular needs. Enterprises such as the one associated with system 10 may operate (or may wish to operate) according to one or more business rules. As examples, some business rules may help ensure that the enterprise is employing best or good business practices, some business rules may ensure accountability and control, some business rules may help ensure quality or timeliness, and some business rules may help minimize or prevent risk or loss. As another example, some business rules may help ensure that an enterprise is complying with one or more government regulations. Typically, business rules are an expression of business requirements and may reflect management intent.

In general, business rules define the bounds of acceptable operation of the business. As an example, a business rule may include one or more conditional expressions that define the bounds of acceptable operation of the business. Business rules are typically policy-level rules and may define one or more business constraints. Business rules may be used to affect the operations of a business (e.g., by limiting the conditions under which a certain operation may be performed), to analyze certain behavior within a business, a combination of these, or for any other suitable purpose. As an example, one form of enterprise analysis, planning, and improvement may include focusing on analysis of the business rules of the enterprise. Business rules may also involve the behavior of people associated with the business, such as employees or clients for example. Business rules are distinguishable from rules of data integrity. For example, a rule of data integrity may specify that a particular value being stored in a database must be an integer. Rather, business rules relate to the intended bounds of enterprise operations. Additionally, some enterprises such as a large, global enterprise may have thousands or tens of thousands of business rules.

Conventionally, business rules have been incorporated into a business in a variety of ways, typically being embedded in computer applications and business processes. For example, business rules may be implemented through human actions directed by instructions or orders (e.g., employee compliance with a manager's instructions). As another example, business rules may be implemented by decisions incorporated into business processes. As another example, business rules may be implemented by computer applications in input edits or business logic, with the business rules being hard-coded into the computer applications. As yet another example, business rules may be implemented through reviews of proposals and/or through inspections.

Embedding business rules in business processes and computer applications may affect edits and process flow. Moreover, embedding business rules in business processes and computer applications typically requires explicit identification of relevant computer applications and business processes that are or may be affected by the business rules, followed by explicit modification of those computer applications and business processes to apply the business rules and provide appropriate actions for handling violations of the business rules.

Furthermore, to analyze or otherwise use the business rules of an enterprise, consultants or employees of the enterprise may be required to manually review the collection of business rules, if such a collection exists. As described above, this may be a particularly burdensome task if an enterprise has a large number of business rules (e.g., a large, global enterprise). As software developers for the enterprise are developing systems or designing business processes, those developers may define what specific decisions would have to be made to comply with the business rules. This may be a difficult, time consuming, and error-prone process for determining how and where to implement the business rules. Moreover, with previous and existing techniques for implementing business rules, it may be difficult to implement a global change to a business rule because, to ensure pervasive implementation of the change, all instances of implementation of that rule would have to be found with no real mechanism for doing so. For example, it may be appropriate or helpful for managers or other individuals to be able to deploy, modify, or delete rules and be assured that the impact of such changes will be effected promptly, consistently, and pervasively throughout an enterprise, if appropriate. However, since the same business rule may be applicable in a variety of circumstances, it may be difficult to identify all affected processes and applications before the fact. This may be particularly difficult when business rules are embedded in computer applications. Additionally, it would be difficult, if possible at all, to understand the consequence of a deploying, modifying, or removing a business rule.

Business rules may relate to actual states of the business as reflected in data stored in one or more operational databases (e.g., operational databases 16) and to constraints on the changes in those states. Typically, business rules become relevant in the execution of a business process when some change of state is to occur that could violate a rule. Consequently, it may be appropriate or useful to invoke relevant business rules at appropriate points in business processes, such as when changes to the stored data are being attempted.

The present invention applies business rules to operational databases 16, which may help resolve one or more of the above-described problems in implementing business rules in an enterprise. Typically, when modifications or other database operations are applied to an operational database 16, one or more relevant business rules may be evaluated, if appropriate. This may help apply relevant business rules at appropriate points in computer applications and other business processes, without requiring the business rule processing to be embedded in those applications and other business processes.

Thus, in general, system 10 is operable to implement business rules in an enterprise by applying the business rules to operational databases 16 such that when modifications or other database operations are applied to one or more operational databases 16, one or more relevant business rules may be evaluated. In certain embodiments, this allows most if not all business processes that affect the data to be affected by relevant business rules. As an example, in certain embodiments, a method for implementing one or more business rules in an entity includes receiving a database operation corresponding to one or more database components of one or more operational databases 16 and invoking, in response to receiving the database operation, a rule evaluation service. The rule evaluation service is operable to (1) determine one or more appropriate business rules to evaluate based on the database operation; (2) evaluate the one or more appropriate business rules to determine whether allowing the database operation to be performed will violate any of the one or more business rules; and (3) determine, if it is determined that allowing the database operation to be performed will violate one or more of the evaluated business rules, an appropriate action to initiate for handling the determined violation.

Throughout this description, implementing business rules includes deploying business rules in system 10, executing business rules in system 10, monitoring business rules in system 10, modifying business rules in system 10, and removing business rules from system 10, executing rules in system 10.

System 10 includes one or more user systems 12. User system 12 may be associated with an enterprise. In particular embodiments, user system 12 and server system 14 are associated with the same enterprise; however, the present invention contemplates the enterprise with which user system 12 is associated being different from the enterprise with which server system 14 is associated. Users of user system 12 may include various employees of the enterprise, employees of a third party providing services to the enterprise, or any other suitable users according to particular needs. User system 12 and users of user system 12 may be referred to interchangeably throughout this description.

Although a single user system 12 is illustrated, the present invention contemplates system 10 including any suitable number of user systems 12 according to particular needs. For example, in certain embodiments, system 10 includes multiple distributed user systems 12. User systems 12 may be physically distributed, being in different physical locations geographically remote from each other and from server system 14, or logically distributed, being at approximately the same location as other user systems 12 and server system 14. Each user system 12 may operate using a different user platform, or two or more users systems 12 may operate using identical user platforms.

Server system 14 includes one or more electronic computing devices operable to receive, transmit, process, and store data associated with system 10. In certain embodiments, server system 14 includes a web server; however, the present invention is not limited to server system 14 being a web server. One function of the web server (or a pool of servers) might be to allow user system 12 to send or receive content over or from the Internet using a standard user interface language such as, for example, Hypertext Markup Language (HTML). In certain embodiments, server system 14 may accept input from user system 12 via a web browser and return appropriate HTML pages.

The one or more user systems 12 and server system 14 may each include one or more computers at one or more locations and may share data storage, communications, or other resources according to particular needs. For example, functionality described in connection with user system 12 and server system 14 may be provided using a single computer system, which in a particular embodiment might include a conventional desktop or laptop computer. Furthermore, functionality described in connection with user system 12 and server system 14 may be provided using any suitable software components. Each computer system may include one or more suitable input devices, output devices, mass storage media, processors, memory, or other components for receiving, processing, storing, and communicating information according to the operation of system 10. The one or more user systems 12 may interact with server system 14 according to suitable input from any number of associated users.

Users systems 12 and server system 14 may each include one or more applications 20. Applications 20 may be implemented in any suitable combination of software, firmware, and hardware. Applications 20 may be written in any suitable language and may serve any suitable purpose. In certain embodiments, applications 20 assist employees or other individuals associated with the enterprise associated with system 10 or a portion of system 10 in performing their jobs. For example, applications 20 may implement one or more business processes of the enterprise associated with system 10. Applications 20 may be client-server applications, web-based applications, applications that run solely on one or more users systems 12, applications that run solely on server system 14, or any other suitable applications.

In general, applications 20 provide users such as users of system 10 with the ability to interact with operational databases 16, either directly or indirectly. For example, applications 20 may allow user system 12 to perform one or more database operations on one or more of operational databases 16. For purposes of this description, a database operation may include querying one or more databases 16 (e.g., requesting data from one or more operational databases 16 in any suitable manner), adding data to one or more operational databases 16, modifying data stored in one or more operational databases 16, deleting data stored in one or more operational databases 16, or performing any other suitable operation with respect to one or more operational databases 16. In certain embodiments, a database operation includes an operation that involves updating one or more of operational databases 16, such as adding data to, deleting data from, or modifying data of one or more operational databases 16.

User system 12 may communicate with server system 14 and may interact with operational databases 16 through server system 14 (e.g., using applications 20 on server system 14 or otherwise). Additionally or alternatively, user system 12 may interact directly with operational databases 16 (e.g., using applications 20 on user system 12 or otherwise). Thus, although system 10 is primarily described as including server system 14, the present invention contemplates system 10 not including server system 14 and user system 12 communicating directly with operational databases 16 (via virtual database 18 if appropriate). Applications 20 may, either alone or through interaction with a user system 12, initiate database operations with respect to operational databases 16.

Operational databases 16 of system 10 are operable to store data associated with applications 20 or any other suitable data associated with the enterprise. In certain embodiments, operational databases 16 may each include one or more database tables 22 for storing one or more data elements. Each operational database 16 may include any memory or database module and may take the form of volatile or non-volatile memory including, without limitation, magnetic media, optical media, random access memory (RAM), read-only memory (ROM), removable media, or any other suitable local or memory component. In particular embodiments, operational databases 16 each include one or more SQL servers. Although a particular number of operational databases 16 is illustrated, system 10 may include any suitable number of operation databases 16 according to particular needs. Additionally, operational databases 16 may each be external or integral to other components of system 10.

Operational databases 16 may be heterogeneous, if appropriate. For example, operational databases 16 may include databases from different vendors, databases associated with different parts of the enterprise (e.g., one operational databases 16 associated with a Human Resources department, one operational database 16 associated with an Order Processing department, and one operational database 16 associated with an Accounting department), databases associated with different offices of the enterprise (e.g., one operational database 16 associated with a New York office of the enterprise and one operational database 16 associated with a London office of the enterprise), and databases that are heterogeneous in any other suitable way. Operational databases 16 may be local to or remote from one another and may be coupled to one another by a network or other suitable mechanism, if appropriate. Each operational database 16 is operable to process database operations in any suitable manner.

In certain embodiments, system 10 includes a virtual database schema 18 that is operable to be mapped to operational databases 16. This may be particularly helpful in embodiments in which operational databases 16 include a plurality of heterogeneous databases such as the databases of a large, global enterprise. In certain embodiments, virtual database schema 18 provides a fully- or partially-integrated, logical composite of one or more operational databases 16. Virtual database schema 18 may abstract the noncontiguous, virtual nature of virtual database schema 18 from user systems 12. Virtual database schema 18 may provide a substantially uniform front-end user interface for interacting with operational databases 16, which may enable users of user systems 12 to store and retrieve data in multiple operational databases 16 with a single database operation, in some cases even if operational databases 16 are heterogeneous. For example, virtual database schema 18 may allow user system 12 to issue database operations against virtual database schema 18 and transforms those database operations into operational database operations against operational databases 16. Virtual database schema 18 may also receive data from one or more operational databases 16 (e.g., in response to a query), compile that data, and present that data to user system 12 as if the data came from the unified viewpoint provided by virtual database schema 18.

Virtual database schema 18 may include an integration tool 26 for mapping virtual database schema 18 to operational databases 16. In certain embodiments, integration tool 26 implements Enterprise Information Integration (EII) technology. In certain embodiments, EII is an integration technology that provides a substantially consistent mechanism for accessing or performing other database operations with respect to multiple, heterogeneous databases. The mappings generated by integration tool 26 may support distributed queries and other database operations with respect to operational databases 16 based on virtual database schema 18. Although integration tool 26 is primarily described as being a part of virtual database schema 18, the present invention contemplates storing integration tool 26 on user system 12, server system 14, one or more of operational databases 16, or any other suitable component of system 10.

In certain embodiments, integration tool 26 (e.g., EII) uses data specifications and mapping techniques based on an Object Management Group (OMG) Common Warehouse Meta-model (CWM) standard to provide virtual database schema 18. In general, the OMG CWM is a specification for modeling metadata for relational, non-relational, multidimensional systems, and other objects found in a data warehousing environment. In certain embodiments, the OMG CWM provides a framework for representing metadata about data sources, data targets, transformations and analysis, and the processes and operations that create and manage warehouse data and provide lineage information about its use. Instances of the meta-model may be exchanged via XML Metadata Interchange (XMI) documents or in any other suitable format.

As described briefly above, system 10 is operable to implement business rules in an enterprise or other suitable entity by applying the business rules to operational databases 16 such that when modifications or other database operations are applied to one or more operational databases 16, one or more relevant business rules may be evaluated.

Business rules may be defined in any suitable manner, according to particular needs. It may be desirable for the business rules to be defined in a substantially consistent manner. For example, in certain embodiments, business rules may be defined according to the Business Semantics of Business Rules specification developed by the OMG. Although this particular example is primarily described, business rules may be defined in any suitable standard form. Using such a standard may facilitate mapping each business rule to one or more corresponding database components to which the business rule applies.

The business rules may be mapped to the one or more appropriate database components of operational databases 16. The mapping of business rules to the appropriate one or more database components may help ensure that the business rules will be evaluated at appropriate times. For purposes of this description, the one or more database components may include one or more operational databases, one or more data tables 22 of one or more operational databases 16, or one or more data elements of one or more data tables 22 of one or more operational databases 16. Thus, a business rule may be mapped to varying levels of granularity such that a business rule may be evaluated in response to a database operation corresponding to one or more operational databases, one or more data tables 22 of one or more operational databases 16, or one or more data elements of one or more data tables 22 of one or more operational databases 16. For example, when an application 20 or user system 12 attempts to perform a database operation with respect to an operational database 16, one or more business rules may need to be evaluated if the database operation affects one or more particular data elements or database tables 22. In certain embodiments, a business rule is mapped to any database component that may potentially violate the business rule if a database operation corresponding to the database component is allowed to be performed.

The present invention contemplates mapping the business rules to one or more appropriate database components of operational databases 16 in any suitable manner, according to particular needs. In certain embodiments, the OMG Business Semantics of Business Rules specification may facilitate this mapping of business rules to one or more appropriate database components of operational databases 16. As described above, in certain embodiments, system 10 includes virtual database schema 18, which may be mapped to operational databases 16 to facilitate distribution of queries or other database operations based on virtual database schema 18. For example, integration tool 26 (e.g., EII) may provide a mechanism for mapping virtual database schema 18 to operational databases 16. In certain embodiments, integration tool 26 uses data models and mapping specifications, such as those based on the OMG CWM standard, to map virtual database schema 18 to operational databases 16.

Virtual database schema 18 may provide a consistent data model for reference by the business rules. For example, the virtual database schema 18 mapping to operational databases 16 may provide a specification for mapping the business rules to the appropriate database components of operational databases 16. In certain embodiments, the business rules are mapped by transformation from the EII virtual database schema 18 to operational databases 16 that are mapped to virtual database 18. Although these techniques for mapping business rules to the one or more appropriate database components of operational databases 16 are primarily described, the present invention contemplates using any suitable technique for mapping the business rules to the one or more appropriate database components of operational databases 16.

In response to receiving certain database operations, operational databases 16 or another suitable component of system 10 are operable to determine one or more appropriate business rules to evaluate based on the received database operation, evaluate the one or more appropriate business rules to determine whether allowing the database operation to be performed will violate any of the one or more business rules, and determine (e.g., if it is determined that allowing the database operation to be performed will violate one or more of the evaluated business rules) an appropriate action to initiate for handling the determined violation. Operational databases 16 or another suitable component of system 10 are operable to perform these functions in any suitable manner, according to particular needs. The following description provides an example technique for implementing these functions.

In certain embodiments, business rules are implemented using stored procedures 24 in operational databases 16. In general, a stored procedure 24 is a program or procedure that may be physically stored within a database such as operational database 16. For example, a stored procedure 24 may include a set of one or more commands (e.g., structured query language (SQL) commands) that can be compiled and stored on a server such as a database server associated with operational database 16. In certain embodiments, an advantage of stored procedures 24 is that when stored procedures 24 are run, in response to a request from user system 12 for example, stored procedures 24 may be run directly by the database engine (e.g., the database engine of an operational database 16), which usually runs on a distinct database server and is generally faster at processing database requests than some other server or computer system. Stored procedures 24 may also allow one or more libraries of functions to be stored on the database server (e.g., operational database 16). Additionally, in certain embodiments, one or more stored procedures 24 of operational databases 16 may be triggers. A trigger is essentially a type of stored procedure 24, such as a stored procedure 24 that is invoked when a particular event occurs. Throughout the remainder of this description, stored procedures and triggers will be referred to collectively as stored procedures 24.

In certain embodiments, one or more stored procedures 24 may be generated for each database component 24 that affect a business rule. For example, in certain embodiments, each database component that may potentially violate a particular business rule if a database operation corresponding to the database component is allowed to be performed may be associated with a stored procedure operable to initiate evaluation of the particular business rule. In response to a database operation that corresponds to a particular database component of operational databases 16 that is associated with a stored procedure 24, the stored procedure 24 of the database component may be invoked. Each stored procedure 24 may be operable to initiate to a determination of whether any business rules associated with the database component corresponding to a database operation will be violated if the database operation is allowed to be performed.

For example, in certain embodiments, system 10 includes a rule evaluation service 28 that is operable to determine one or more appropriate business rules to evaluate based on a database operation, evaluate the one or more appropriate business rules to determine whether allowing the database operation to be performed will violate any of the one or more appropriate business rules, and determine (e.g., if it is determined that allowing the database operation to be performed will violate one or more of the evaluated business rules) an appropriate action to initiate for handling the determined violation. In certain embodiments, each stored procedure 24 may invoke rule evaluation service 28 to determine if any business rules associated with the database component corresponding to the database operation will be violated if the database operation is allowed to be performed. In other words, rule evaluation service 28 may evaluate each of the business rules that might be affected by the change of state requested by the database operation and identified to rule evaluation service 28 by the stored procedure 24.

In certain embodiments, this may allow the linkage for evaluation of all business rules that correspond to a particular database component to use only one stored procedure 24 for each relevant database component. For example, a single stored procedure 24 corresponding to a particular operational database 16 may cause all business rules for the particular operational database 16 to be evaluated in response to receiving a database operation corresponding to the particular operational database 16. As another example, a single stored procedure 24 corresponding to a particular database table 22 of an operational database 16 may cause all business rules for the particular database table 22 to be evaluated in response to receiving a database operation corresponding to the particular database table 22. As yet another example, a single stored procedure 24 corresponding to a particular data element of a database table 22 of an operational database 16 may cause all business rules for the particular data element to be evaluated in response to receiving a database operation corresponding to the particular data element.

Rule evaluation service 28 may be implemented in any suitable combination of hardware, firmware, and software. Rule evaluation service 28 may include a database or other suitable memory module, a server system, or any other suitable computing module, according to particular needs. The present invention contemplates rule evaluation service 28 being integral to or external to any suitable component of system 10. In certain embodiments, the functionality described with reference to rule evaluation service 28 may be incorporated into each of stored procedures 24.

Rule evaluation service 28 may store business rule information 30 for each business rule in a rule registry 32. Rule registry 32 may include information regarding all of the business rules associated with system 10, if appropriate. Rule information 30 may include certain information regarding each rule. Although rule registry 32 is described as including particular types of rule information 30 regarding each business rule, rule registry 32 may include any suitable information regarding each business rule, according to particular needs. For example, for each business rule, rule information 30 may include one or more of the following: (1) an algorithm for the business rule; (2) an identification of the one or more database components affected by the business rule one or more operational databases 16, database tables 22, or data elements affected by the business rule; (3) the level of enforcement for the business rule; and (4) explanatory information regarding the business rule. Each of these is described in greater detail below.

Each business rule may be associated with one or more algorithms for evaluating the business rule. In certain embodiments, the algorithm comprises one or more conditional expressions for the business rule. For example, a conditional expression for a business rule may express a true-false or other binary condition indicating on what conditions a TRUE or FALSE value should be returned. The identification of the one or more database components affected by the business rule may include an identification of one or more operational databases 16, one or more database tables 22 of one or more operational databases 16, and/or one or more data elements of one or more database tables 22 of one or more operational databases 16 that may be affected by the business rule. The granularity of this identification for a particular business rule may depend on the granularity of the mapping between the business rule and operational databases 16. These one or more identifications may facilitate determining which business rules to evaluate in response to a stored procedure 24 invoking rule evaluation service 28. For example, an invocation by a stored procedure may identify the particular database component that is invoking rule evaluation service 28, and to determine the one or more business rules to evaluate in response to the invocation, rule evaluation service 28 may search rule registry 32 for business rules that have rule information 30 identifying the identified database component.

The enforcement level for a business rule may include information that may be interpreted to determine the appropriate action to be taken in response to determining that allowing a particular database operation to be performed will violate one or more evaluated business rules. For example, the enforcement level for a business rule may specify that, in response to determining that allowing a particular database operation to be performed will violate one or more evaluated business rules, one or more of the following actions should be performed: (1) the particular database operation should be denied; (2) an explanation for the determined violation of the business rule should be provided; (3) the particular database operation should be allowed, but special authorization is required; (4) the particular database operation is allowed, but a process should be initiated to compensate for the consequences of the business rule violation; (5) a notice of the determined violation is generated for monitoring; or (6) any other suitable action. Explanatory information regarding the business rule may include a textual or other suitable statement of the reason for the business rule that can be used to explain a determined violation of the business rule. The explanatory information may be used, for example, to provide an explanation for the determined violation of a business rule if required by the enforcement level of the business rule.

As described above, rule evaluation service 28 may be invoked by stored procedures 24 of operation databases 16 to evaluate one or more appropriate business rules. In response to an invocation request by a stored procedure 24, rule evaluation service 28 may determine one or more appropriate business rules to evaluate based on the database operation. The invocation request received by rule evaluation service 28 from a stored procedure 24 may include one or more parameters. For example, the invocation request may include one or more details regarding the database operation received that caused the stored procedure 24 to invoke rule evaluation service 28. As a particular example, for a database operation that includes a request to modify a data value in an operational database 16, the parameters may include the current value stored in the database and the new value proposed in the database operation. As another example, the invocation request may include an identifier of the database component corresponding to the database operation. In certain embodiments, the stored procedure 24 corresponds to this database component such that when a database operation corresponds to this database component, the stored procedure 24 invokes rule evaluation service 28 to evaluate one or more, if not all, business rules associated with that database component. The invocation request received from a stored procedure 24 may include any other suitable parameters, according to particular needs.

The one or more appropriate business rules may include those business rules that might be affected by the database operation, determined by accessing rule registry 32 for example. For example, rule evaluation service 28 may select the business rules that are mapped to the database component that initiated the stored procedure 24 (i.e., a database component to which the database operation corresponds).

Rule evaluation service 28 may evaluate the one or more appropriate business rules to determine whether allowing the database operation to be performed will violate any of the one or more appropriate business rules. In certain embodiments, for each of the appropriate business rules, rule evaluation service 28 may process the rule algorithm for the business rule, using one or more parameters communicated with the invocation request for example. Rule evaluation service 28 may access rule information 30 for each of the appropriate business rules to determine the appropriate algorithm for the business rule.

In certain embodiments, rule evaluation service 28 may obtain or determine certain appropriate data for use in evaluating the one or more appropriate business rules from the one or more parameters of the invocation request received from stored procedure 24. For example, the invocation request may include one or more details regarding the database operation received that caused the stored procedure 24 to invoke rule evaluation service 28. Additionally or alternatively, in certain embodiments, rule evaluation service 28 may access data tables 22 or data elements in one or more operational databases 16 to obtain or determine any relevant data for evaluating the appropriate business rules. For example, rule evaluation service 28 may use virtual database schema 18 to access data tables 22 or data elements in one or more operational databases 16 to obtain or determine any relevant data for evaluating the appropriate business rules. As a particular example, rule evaluation service 28 may use integration tool 26 (e.g., EII) to evaluate business rules against multiple operational databases 16 based on virtual database schema 18. This may involve rule evaluation service 28 issuing one or more queries of one or more operational databases 16 using virtual database schema 18. The appropriate queries may be stored in rule information 30 for the business rule being evaluated.

Based on the determination of whether a database operation will violate any appropriate business rule if the database operation is allowed to be performed, rule evaluation service 28 may determine the consequences of the violation determination. For example, if rule evaluation service 28 determines that allowing the database operation to be performed will not violate any of the evaluated business rules, rule evaluation service may communicate a notification or other suitable indication, to the stored procedure that invoked rule evaluation service for example, that the database operation should be allowed. As another example, rule evaluation service 28 may be operable to determine, if it is determined that allowing the database operation to be performed will violate one or more of the evaluated business rules, an appropriate action to initiate for handling the determined violation. In certain embodiments, the appropriate action may be determined based on the rule information 30 for the one or more relevant business rules, such as the enforcement level of the business rule that will be violated if the database operation is allowed to be performed. Example actions that may be performed if it is determined that the database operation will violated one or more business rules if the database operation is allowed to be performed are described below.

For example, rule evaluation service 28 may return a violation code or other suitable identifier indicating that a violation will occur if the requested database operation is allowed to be performed. In certain embodiments, the violation code may be returned to the stored procedure 24 that communicated the invocation request to rule evaluation service 28. As another example, rule evaluation service 28 may return an explanation for the determined rule violation. In certain embodiments, this explanation may be based on rule information 30 for the violated business rule, including for example the explanatory information regarding the violated business rule. As another example, rule evaluation service 28 may return a violation code or other suitable identifier indicating that the database operation should be denied. As another example, rule evaluation service 28 may return a violation code or other suitable identifier indicating that the database operation should be allowed, but only with special authorization. This authorization may include, for example, the authorization of a manager or other appropriate individual of sufficient authority. As another example, rule evaluation service 28 may return a violation code or other suitable identifier indicating that the database operation should be allowed, but that a process should be initiated to compensate for the consequences of the determined business rule violation. As another example, rule evaluation service 28 may generate or initiate generation of a notification of the business rule violation. The notification may be in any suitable format and may include any suitable information, according to particular needs. The notification may be used to initiate an appropriate action, to support monitoring, or for any other suitable purpose. Although violation of a single rule has been primarily described, a requested database operation could violate multiple rules. In such embodiments, rule evaluation service 28 may return a list of violation codes, the violation code of only the most severe violation, or any other suitable information.

In certain embodiments, rule evaluation service 28 or another suitable component of system 10 may store information regarding determined violations of business rules. For example, rule evaluation service 28 may store information regarding determined violations of business rules in a database or other suitable memory module. The information stored regarding the determined violations of business rules may include an identification of the business rule violated, the number of times the business rule was violated, the explanatory information for the violation (e.g., based on rule information 30 for the violated business rule), the date and time of the violation, the database operation that resulted in the violation, or any other suitable information. The information regarding the determined violations of business rules may be stored if action is delayed as a result of violation of the business rule or at any other suitable time, according to particular needs. The explanatory information regarding the rule may be included in the stored information so that a reviewer of the stored information can identify the business rule and the meaning of the violation of the business rule.

In operation of an example embodiment of system 10, a business rule may be deployed within system 10. The business rule may be deployed at build time, at run time, or at any other suitable time according to particular needs. Although deploying a single business rule is primarily described, the present invention contemplates deploying multiple business rules. A business rule to be deployed may be identified. The business rule to be deployed may be identified in any suitable manner, according to particular needs. The identified business rule may be defined. In certain embodiments, the identified business rule may be defined in a standard form, such as the form provided by the OMG Business Semantics of Business Rules specification.

The business rule may be mapped to one or more database components of operational databases 16. Depending on the level of granularity desired, mapping a business rule to one or more database components may include one or more of mapping the business rule to one or more operational databases 16, mapping the business rule to one or more database tables 22 of one or more operational databases 16, and mapping the business rule to one or more data elements of one or more database tables 22 of one or more operational databases 16. In embodiments of system 10 that include virtual database schema 18, the business rule may be mapped to one or more appropriate database components by accessing virtual database schema 18 and determining, using virtual database schema 18, the one or more database components for which the business rule should be evaluated when a database operation corresponding to that database component is received. For example, a business rule may be mapped to one or more appropriate database components using EII and the OMG CWM standard, which may facilitate mapping the business rule to the appropriate one or more database components of operational databases 16.

One or more stored procedures 24 to be executed in response to receiving a database operation corresponding to the one or more database components may be created for the business rule. For example, a stored procedure 24 may be created for each database component to which the business rule is mapped. Rule registry 32 of rule evaluation service 28 may be updated with rule information 30 for the business rule being deployed. In certain embodiments, rule information 30 includes one or more of an algorithm for evaluating the business rule; an identification of the one or more database components affected by the business rule; the level of enforcement for the business rule; and explanatory information regarding the business rule.

In certain embodiments, when a business rule is deployed or is being considered for deployment, various circumstances may already exist in the database components of operational databases 16 that could violate the business rule. For example, based on the business rule being deployed or being considered for deployment, a value in a first database table 22 of a first operational database 16 may be an improper value in light of another value in a second database table 22 of a second operational database 16. Evaluation of business rules in response to one or more database queries (e.g., a database operation comprising a database query) may help identify such existing violations. In certain embodiments, when a rule is being deployed or being considered for deployment, a database operation such as a database query may be communicated to operational databases 16 to determine and/or report existing violations of the business rules. This ability may be useful for determining the potential impact of deploying the business rule (e.g., in addition to or as an alternative to deploying a business rule with a notification-only level of enforcement, as described below).

In operation of an example embodiment of system 10, business rules may be removed from system 10. The business rule may be removed at build time, at run time, or at any other suitable time according to particular needs. Although removing a single business rule is primarily described, the present invention contemplates removing multiple business rules. A business rule to be removed may be identified. The business rule to be removed may be identified in any suitable manner, according to particular needs.

The mappings between the identified business rule and one more database components of one or more operational databases 16 may be determined. Depending on the level of granularity desired at which the business rule was mapped at its deployment, the mapping of the business rule to one or more database components may include one or more of mappings to one or more operational databases 16, mappings to one or more database tables 22 of one or more operational databases 16, and mappings to one or more data elements of one or more database tables 22 of one or more operational databases 16. In embodiments of system 10 that include virtual database schema 18, the mapping of the business rule to one or more appropriate database components may be determined by accessing virtual database schema 18 and determining, using virtual database schema 18, the one or more database components for which the business rule should be evaluated when a database operation corresponding to that database component is received. For example, a business rule may be mapped to one or more appropriate database components using EII and the OMG CWM standard, which may facilitate mapping the business rule to the appropriate one or more database components of operational databases 16. Additionally or alternatively, the mapping of the business rule to one or more appropriate database components may be determined by accessing rule registry 32 and determining, using rule information 30, the one or more database components for which the business rule should be evaluated when a database operation corresponding to that database component is received.

In certain embodiments, if appropriate, one or more stored procedures 24 that correspond to the identified business rule may be removed from the operational databases 16 associated with the database components to which the business rule is determined to be mapped. As described in more detail below with reference to FIG. 3, it may not be appropriate to remove one or more stored procedures 24, if those stored procedures 24 may cause other business rules to be evaluated for example. Rule registry 32 of rule evaluation service 28 may be updated to remove rule information 30 for the business rule being removed. In certain embodiments, rule information 30 for the business rule being removed is not deleted, but is flagged in some way to indicate that it is not active with respect to any business rule. For example, the portion of rule information 30 identifying the one or more database components affected by the business rule may be blank, indicating that no database component is affected by the removed business rule.

In operation of an example embodiment of system 10, business rules may be executed, at run time for example. A database operation may be received, from user system 12 for example. The database operation may be received from user system 12, automatically from an application 20, or in any other suitable manner. One or more stored procedures 24 may be executed in response to the received database operation. For example, one or more stored procedures 24 (i.e., those stored procedures 24 created for one or more business rules) may be executed to invoke rule evaluation service 28 for evaluation of one or more appropriate business rules based on the received database operation. The stored procedure 24 may communicate an invocation request, which may include one or more suitable parameters, to rule evaluation service 28.

Rule evaluation service 28 may receive the invocation request to evaluate one or more appropriate business rules. In response to the request, rule evaluation service 28 may determine the one or more appropriate business rules to be evaluated. For example, rule evaluation service 28 may access rule registry 32 to determine the appropriate business rules to evaluate in response to the database operation. Rule evaluation service 28 may determine which rules to evaluate based on rule information 30 and one or more parameters of the invocation request received from a stored procedure 24.

Rule evaluation service 28 may evaluate the one or more appropriate business rules to determine whether allowing the database operation to be performed will violate any of the one or more appropriate business rules. For example, rule evaluation service 28 may evaluate an appropriate business rule (e.g., a business rule determined to be appropriate at step 406) by evaluating the algorithm for the business rule, as specified in rule information 30 for the business rule. In certain embodiments, rule evaluation service 28 may obtain or determine certain appropriate data for use in evaluating the one or more appropriate business rules from the one or more parameters of the invocation request received from stored procedure 24. Additionally or alternatively, in certain embodiments, rule evaluation service 28 may access data tables 22 or data elements in one or more operational databases 16 to obtain or determine any relevant data for evaluating the appropriate business rules. For example, rule evaluation service 28 may use virtual database schema 18 to access data tables 22 or data elements in one or more operational databases 16 to obtain or determine any relevant data for evaluating the appropriate business rules.

If rule evaluation service 28 determines that a business rule will not be violated if the requested database operation is allowed to be performed, then rule evaluation service 28 may return a code or other suitable identifier indicating that no violation will occur. The present invention contemplates any other suitable technique for handling non-violations of business rules.

If rule evaluation service 28 determines that a business rule will be violated if the requested database operation is allowed to be performed, then rule evaluation service 28 may initiate or perform any number of appropriate actions, either alone or in combination. Rule evaluation service 28 may determine the appropriate action to initiate or perform based on rule information 30 for the one or more violated business rules, including for example the level of enforcement for the one or more violated business rules.

For example, rule evaluation service 28 may return a violation code or other suitable identifier indicating that a violation will occur if the requested database operation is allowed to be performed. In certain embodiments, the violation code may be returned to the stored procedure 24 that communicated the invocation request to rule evaluation service 28. As another example, rule evaluation service 28 may return an explanation for the determined rule violation. In certain embodiments, this explanation may be based on rule information 30 for the violated business rule, including for example the explanatory information regarding the violated business rule. As another example, rule evaluation service 28 may return a violation code or other suitable identifier indicating that the database operation should be denied. As another example, rule evaluation service 28 may return a violation code or other suitable identifier indicating that the database operation should be allowed, but only with special authorization. This authorization may include, for example, the authorization of a manager or other appropriate individual of sufficient authority. As another example, rule evaluation service 28 may return a violation code or other suitable identifier indicating that the database operation should be allowed, but that a process should be initiated to compensate for the consequences of the determined business rule violation. As another example, rule evaluation service 28 may generate or initiate generation of a notification of the business rule violation. The notification may be in any suitable format and may include any suitable information, according to particular needs. The notification may be used to initiate an appropriate action, to support monitoring, or for any other suitable purpose. Although violation of a single rule has been primarily described, a requested database operation could violate multiple rules. In such embodiments, rule evaluation service 28 may return a list of violation codes, the violation code of only the most severe violation, or any other suitable information.

In certain embodiments, rule evaluation service 28 or another suitable component of system 10 may store information regarding determined violations of business rules. For example, rule evaluation service 28 may store information regarding determined violations of business rules in a database or other suitable memory module. The information stored regarding the determined violations of business rules may include an identification of the business rule violated, the number of times the business rule was violated, the explanatory information for the violation (e.g., based on rule information 30 for the violated business rule), the date and time of the violation, the database operation that resulted in the violation, or any other suitable information. The information regarding the determined violations of business rules may be stored if action is delayed as a result of violation of the business rule or at any other suitable time, according to particular needs. The explanatory information regarding the rule may be included in the stored information so that a reviewer of the stored information can identify the business rule and the meaning of the violation of the business rule.

In certain embodiments, detection of a business rule violation may affect one or more applications 20, such as the application 20 used to initiate the database operation that resulted in the determined violation. The effect of the violation on application 20 may be implemented in a variety of ways, examples of which are described below.

In certain embodiments, rule evaluation service 28 or another suitable component of system 10 such as a component of the operational database 16 affected by the update may return violation information as a return code for action by application 20. The handling for the return violation may be built into the exception handling capabilities of application 20. In certain embodiments, a violation table may be added to one or more of operational databases 16 to identify transactions (e.g., database operations) that violated a business rule, the reason for each violation, and any other suitable information. When a violation occurs and the database operation is denied, the violation table may be referenced to determine the reason the database operation was denied. In such embodiments, application 20 may access the operational database 16 to determine if a rule violation has occurred in situations in which the database operation was not denied. In certain embodiments, rule evaluation service 28 or another suitable component of system 10 may generate a notification. In certain embodiments, the notification may be an asynchronous message, although the present invention contemplates the notification having any suitable format according to particular needs. This approach may be useful for monitoring. In this example, it may be helpful for a determined violation for a database operation to be handled through corrective action after the database operation is allowed. The above-described example techniques for handling rule violations may be used alone or in combination. Additionally, a determined business rule violation may affect one or more applications 20 in any other suitable manner.

Applications 20 may handle rule violations in any suitable manner, according to particular needs. In certain embodiments, application 20 is operable to perform certain exception processing. In such embodiments, if application 20 receives an indication from an operational database 16 or other suitable component of system 10 that a violation of a business rule has been determined for a database operation, application 20 may handle this indication in any suitable manner, based on the built-in exception processing of application 20. This technique may be particularly applicable to new applications 20. As another example, where existing applications 20 (e.g., legacy applications) have been web-enabled or are orchestrated by an explicit business process (i.e., the applications have been adapted to a Service Oriented Architecture), then a determination of a business rule violation may be intercepted, an explanation provided, and appropriate action taken. For other existing applications 20 (e.g., legacy applications), the database operation may be allowed and corrective action may be initiated through one or more messages, for example. It may be desirable for the logic of application 20 to depend on rule evaluation service 28 to determine if a database operation will violate one or more business rules if the database operation is allowed to be performed in order to allow modification or removal of the business rule to have substantially immediate impact on the business operations.

In certain embodiments, system 10 supports various procedures for implementing a business rule that incorporate certain monitoring of a business rule to determine the proper or desired implementation of the business rules. For example, a new business rule may be identified that the management of the enterprise associated with system 10 would like to deploy throughout the enterprise. It may be useful to deploy the business rule without any hard exceptions. For example, it may be desirable to deploy the business rule such that when a violation of the business rule is determined, the database operation that caused the determined violation is allowed but a notification that the database operation violated one or more business rules is generated. This may allow users associated with system 10 to determine certain statistical information associated with the new business rule. For example, the statistical information may include where the business rule is violated (e.g., from which user systems 12 database operations that violate the business rule are generated), how often the business rule is violated, or any other suitable statistical information. In certain embodiments, an informed decision may then be made, based on this statistical information, regarding how or whether the business rule should be enforced (e.g., the level of enforcement for the business rule). As a particular example, the enforcement level of the business rules may be altered to include certain actions initiated if one of the business rules is violated. As another example, these monitoring techniques may be used for determining whether to remove or modify existing business rules.

In operation of an example embodiment of system 10, a business rule may be implemented with notification only so that the occurrence of determined violations can be monitored and the impact evaluated. In certain embodiments, notification messages, such as emails, text messages, communications sent to a pager device, or any other suitable notification may be generated and delivered to suitable personnel such as the organization responsible for business rule violations. The recipients may initiate corrective action and provide feedback on the effects of the business rule. Based on the feedback received, one or more applications 20 may be updated to automate appropriate action in response to a determined violation of the business rule. This methodology may allow a business rule to be monitored, evaluated, and tailored based upon feedback received through actual implementation of the business rule.

In certain embodiments, system 10 supports various procedures for removing one or more business rule that incorporate tracking the implemented rules. In operation of an example embodiment of system 10, the occurrence of determined business rule violations may be monitored (e.g., through the use of notifications) to determine the frequency and circumstances of the rule violations and to determine the affected organizations. The monitoring may be changed to report determined violations to the responsible organizations, so that the impact of the change can be evaluated in context. The business rule may be changed to support monitoring only. For example, the business rule information 30 in rule registry 32 may be changed to only require notifications in response to the rule violations for that business rule.

In certain embodiments, user systems 12, server system 14, operational databases 16, virtual database 18, and rule evaluation service 28 may be coupled using one or more links 36. Each of links 36 may include one or more local area networks (LANs), metropolitan area networks (MANs), wide area networks (WANs), radio access networks (RANs), a global computer network such as the Internet, or any other wireline, optical, wireless, or other links. Each of links 36 may communicate, for example, IP packets, Frame Relay frames, or Asynchronous Transfer Mode (ATM) cells to communicate voice, video, data, and other suitable information between network addresses.

Moreover, although the components of system 10 are described as separate, the present invention contemplates omitting certain components, combining certain components, or other variations without departing from the spirit and scope of the present invention. For example, as described briefly above, the present invention contemplates system 10 not including server system 14 and user systems 12 interacting directly with operational databases 16, using virtual database schema 18 if appropriate. As another example, rule evaluation service 28 may be combined with server system 14, each operational database 16, virtual database schema 18, or any other suitable component of system 10.

Particular embodiments of the present invention may provide one or more technical advantages. Previous and existing techniques for implementing business rules often involve embedding the business rules in computer applications 20 or other business processes of an entity. In some cases, business rules may be simply by word-of-mouth or verbal instructions from managers or other individuals. These and other techniques may make deploying, monitoring, executing, modifying, and/or removing business rules difficult, if possible at all.

In certain embodiments, the present invention may enable consistent application of business rules throughout an enterprise. In certain embodiments, the present invention allows business rules to be transformed from a high level rule describing the bounds of acceptable operation of the enterprise to business rules that may be evaluated with respect to changes in one or more operational databases 16. In certain embodiments, the present invention uses virtual database schema 18 for one or more operational databases 16 to create a stored procedure 24 for one or more business rules that may be executed in response to database operations to initiate evaluation of the one or more business rules and to raise an exception if it is determined that allowing the database operation to be performed will violate one or more of the business rules.

Certain rule processing logic may be generally independent of affected computer applications 20. In certain embodiments, the present invention provides a mechanism for monitoring violations of business rules such as the generation of an event when a violation is detected. In certain embodiments, certain rule processing may be substantially separate from one or more applications 20, and the one or more applications 20 may determine the consequences of violating a business rule. In certain embodiments, the present invention provides a mechanism, which in certain embodiments may be automated, for pervasively deploying, executing, monitoring, modifying, and removing business rules. The present invention may enable managers or other suitable individuals or computer applications 20 to deploy, execute, monitor, modify, and remove business rules and be assured that the impact of such changes will be effected promptly, consistently, and pervasively throughout an enterprise, if appropriate. The present invention may help entities such as business enterprises by providing agility and assisting in compliance with government regulations. The present invention may enable application of business rules to legacy applications 20 as well as new applications 20, so that business rules can be implemented throughout the enterprise with minimal impact on existing applications 20.

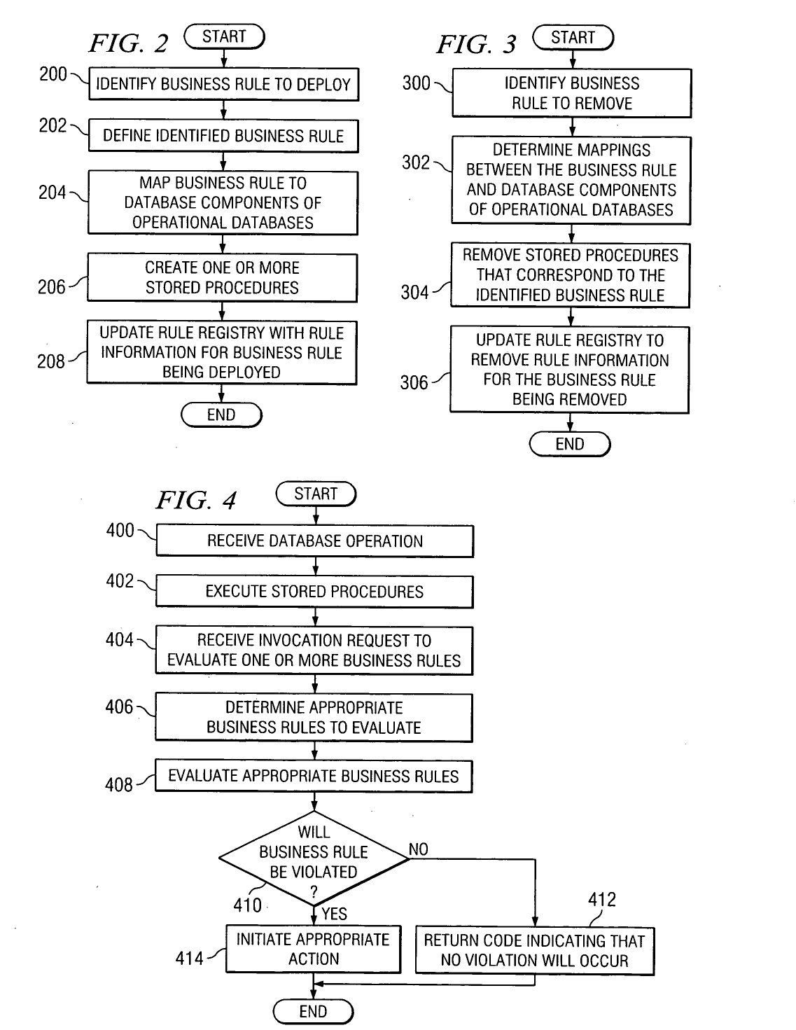

FIG. 2 illustrates an example method for deploying a business rule according to certain embodiments of the present invention. The business rule may be deployed at build time, at run time, or at any other suitable time according to particular needs. Although deploying a single business rule is primarily described with reference to FIG. 2, the present invention contemplates deploying multiple business rules.

At step 200, a business rule to be deployed may be identified. For example, a business rule may be identified by reviewing government regulations for a particular business practice. As another example, a business rule may be identified by one or more managers. As another example, a business rule may be identified by reviewing and/or identifying one or more best practices of an enterprise. As another example, a business rule may be identified through tracking a business rule that has been implemented with notification only so that the occurrence of violations can be monitored and the impact evaluated. In certain embodiments, implementing a business rule with monitoring only may allow the identified business rule to be tailored prior to its actual enforcement within system 10. Although particular example techniques for identifying a business rule for deployment have been described, business rules may be identified for deployment in any suitable manner, according to particular needs.

At step 202, the identified business rule may be defined. In certain embodiments, the identified business rule may be defined in a standard form, such as the form provided by the OMG Business Semantics of Business Rules specification. Although defining the identified business rule in a standard form is primarily described, business rules may be defined in any suitable manner, according to particular needs.

At step 204, the business rule may be mapped to one or more database components of operational databases 16. Depending on the level of granularity desired, mapping a business rule to one or more database components may include one or more of mapping the business rule to one or more operational databases 16, mapping the business rule to one or more database tables 22 of one or more operational databases 16, and mapping the business rule to one or more data elements of one or more database tables 22 of one or more operational databases 16. In embodiments of system 10 that include virtual database schema 18, the business rule may be mapped to one or more appropriate database components by accessing virtual database schema 18 and determining, using virtual database schema 18, the one or more database components for which the business rule should be evaluated when a database operation corresponding to that database component is received. For example, a business rule may be mapped to one or more appropriate database components using using EII and the OMG CWM standard, which may facilitate mapping the business rule to the appropriate one or more database components of operational databases 16. Although mapping the identified business rule using EII and the OMG CWM standard is primarily described, business rules may be mapped in any suitable manner, according to particular needs.

At step 206, one or more stored procedures 24 to be executed in response to receiving a database operation corresponding to the one or more database components may be created for the business rule. For example, a stored procedure 24 may be created for each database component to which the business rule is mapped. As described above, stored procedures 24 may be executed in response to receiving a database operation corresponding to a database component associated with the stored procedure 24. Additionally, stored procedures 24, when executed, may be operable to invoke rule evaluation service 24. In certain embodiments, if a particular database component is already associated with a stored procedure 24 for invoking rule evaluation service 24 (e.g., based on deployment of another business rule), the stored procedure 24 may or may not need to be modified based on the business rule being deployed. Alternatively, a new stored procedure 24 may be created for the business rule being deployed.

At step 208, rule registry 32 of rule evaluation service 28 may be updated with rule information 30 for the business rule being deployed. In certain embodiments, rule information 30 includes one or more of an algorithm for evaluating the business rule; an identification of the one or more database components affected by the business rule; the level of enforcement for the business rule; and explanatory information regarding the business rule.

FIG. 3 illustrates an example method for removing a business rule according to certain embodiments of the present invention. The business rule may be removed at build time, at run time, or at any other suitable time according to particular needs. Although removing a single business rule is primarily described with reference to FIG. 3, the present invention contemplates removing multiple business rules.

At step 300, a business rule to be removed is identified. For example, a business rule may be identified by one or more managers. As another example, a business rule may be identified through tracking a business rule. The occurrence of violations of the business rule may be monitored (e.g., through the use of notifications), for example, to determine the frequency and circumstances of the rule violations and to determine the affected organizations. If appropriate, the business rule may be changed to support monitoring only. Although particular example techniques for identifying a business rule for removal have been described, business rules may be identified for removal in any suitable manner, according to particular needs.

At step 302, the mappings between the identified business rule and one more database components of one or more operational databases 16 may be determined. Depending on the level of granularity desired at which the business rule was mapped at its deployment, the mapping of the business rule to one or more database components may include one or more of mappings to one or more operational databases 16, mappings to one or more database tables 22 of one or more operational databases 16, and mappings to one or more data elements of one or more database tables 22 of one or more operational databases 16. In embodiments of system 10 that include virtual database schema 18, the mapping of the business rule to one or more appropriate database components may be determined by accessing virtual database schema 18 and determining, using virtual database schema 18, the one or more database components for which the business rule should be evaluated when a database operation corresponding to that database component is received. For example, a business rule may be mapped to one or more appropriate database components using using EII and the OMG CWM standard, which may facilitate mapping the business rule to the appropriate one or more database components of operational databases 16.

Although determining the mapping of the business rule using EII and the OMG CWM standard is primarily described, the mapping of the business rule to its one or more appropriate database components may be determined in any suitable manner, according to particular needs. For example, the mapping of the business rule to one or more appropriate database components may be determined by accessing rule registry 32 and determining, using rule information 30, the one or more database components for which the business rule should be evaluated when a database operation corresponding to that database component is received.

At step 304, one or more stored procedures 24 that correspond to the identified business rule may be removed from the operational databases 16 associated with the database components to which the business rule is determined to be mapped. In certain embodiments, the removal of the stored procedures 24 corresponding to the identified business rule may terminate invocation of the rule evaluation service 28 when a database operation corresponding to the database component associated with the stored procedure 24 is received. However, in certain embodiments, rule evaluation service 28 may still be invoked in response to a database operation corresponding to that database component, if another business rule is affected by that database operations corresponding to that database component for example. In such embodiments, one or more stored procedures 24 that correspond to the identified business rule may or may not be removed. For example, in certain embodiments, a stored procedure 24 for a database component may simply indicate that at least one business rule is associated with that database component and that when a database operation is requested with respect to that database component, stored procedure 24 communicates an invocation request to rule evaluation service 28. In response to the invocation request, rule evaluation 28 may evaluate all or multiple business rules that correspond to that database component. Thus, it may not be appropriate to remove a stored procedure 24 for a particular database component when removing a business rule that affects the particular database component because the stored procedure 24 may cause other business rules affected by the database component to be evaluated.

At step 306, rule registry 32 of rule evaluation service 28 may be updated to remove rule information 30 for the business rule being removed. In certain embodiments, rule information 30 for the business rule being removed is not deleted, but is flagged in some way to indicate that it is not active with respect to any business rule. For example, the portion of rule information 30 identifying the one or more database components affected by the business rule may be blank, indicating that no database component is affected by the removed business rule.

FIG. 4 illustrates an example method for executing one or more business rules according to certain embodiments of the present invention. In certain embodiments, the one or more business rules may be executed at run time.

At step 400, a database operation may be received, from user system 12 for example. As described above, the database operation may include a request to query one or more databases 16 (e.g., requesting data from one or more operational databases 16 in any suitable manner), a request to add data to one or more operational databases 16, a request to modify data stored in one or more operational databases 16, a request to delete data stored in one or more operational databases 16, or a request to perform any other suitable operation with respect to one or more operational databases 16. In certain embodiments, the database operation includes an operation that involves updating one or more of operational databases 16, such as adding data to, deleting data from, or modifying data of one or more operational databases 16. The database operation may be received from user system 12, automatically from an application 20, or in any other suitable manner.

At step 402, one or more stored procedures 24 may be executed in response to the received database operation. For example, one or more stored procedures 24 (i.e., those stored procedures 24 created for one or more business rules) may be executed to invoke rule evaluation service 28 for evaluation of one or more appropriate business rules based on the received database operation. The stored procedure 24 may communicate an invocation request, which may include one or more suitable parameters, to rule evaluation service 28.

At step 404, rule evaluation service 28 may receive the invocation request to evaluate one or more appropriate business rules. As described above, the request may include one or more parameters. At step 406, in response to the request, rule evaluation service 28 may determine the one or more appropriate business rules to be evaluated. For example, rule evaluation service 28 may access rule registry 32 to determine the appropriate business rules to evaluate in response to the database operation. Rule evaluation service 28 may determine which rules to evaluate based on rule information 30 and the one or more parameters of the invocation request received from a stored procedure 24. For example, the parameters of the invocation request may include an identification of the stored procedure that invoked the request, an identification of the database component corresponding to the database operation that cause the stored procedure to be executed, or any other suitable information. Rule evaluation service 28 may use the parameters to determine the appropriate one or more business rules to evaluate. For example, rule information 30 of each business rule in rule registry 32 may include an identification of the one or more database components affected by the business rule. Rule evaluation service 28 may compare this rule information 30 to one or more parameters of the invocation request to determine whether a business rule should be evaluated. In such embodiments, multiple business rules may be evaluated based on a single request. For example, rule information 30 for multiple business rules may include an identification of the database component that cause the stored procedure 24 to be executed. Thus, in certain embodiments, each of these business rules may be evaluated in response to the invocation request.

At step 408, rule evaluation service 28 may evaluate the one or more appropriate business rules to determine whether allowing the database operation to be performed will violate any of the one or more appropriate business rules. For example, rule evaluation service 28 may evaluate an appropriate business rule (e.g., a business rule determined to be appropriate at step 406) by evaluating the algorithm for the business rule, as specified in rule information 30 for the business rule. In certain embodiments, as described above, the invocation request received at step 404 by rule evaluation service 28 may include one or more parameters. These parameters may include certain information regarding the database operation received at step 400. As just one example, the parameters may include information regarding an existing value in operational database 16 and a new value to which the database operation is attempting to change that existing value. Rule evaluation service 28 may use that information to evaluate the algorithm for the business rule. Additionally or alternatively, in certain embodiments, rule evaluation service 28 may access data tables 22 or data elements in one or more operational databases 16 to obtain or determine any relevant data for evaluating the appropriate business rules. For example, rule evaluation service 28 may use virtual database schema 18 to access data tables 22 or data elements in one or more operational databases 16 to obtain or determine any relevant data for evaluating the appropriate business rules.

At step 410, rule evaluation service may determine whether one or more evaluated business rules will be violated if the database operation is allowed to be performed. Although steps 408 and 410 are described separately, in certain embodiments, steps 408 and 410 may be performed as essentially a single step.

If rule evaluation service 28 determines at step 410 that a business rule will not be violated if the requested database operation is allowed to be performed, then at step 412 rule evaluation service 28 may return a code or other suitable identifier indicating that no violation will occur. The present invention contemplates any other suitable technique for handling non-violations of business rules. For example, a notification may be sent to one or more appropriate individuals or applications 20 indicating that a particular business rule was evaluated and no violation was determined. As another example, certain details associated with the evaluation of the business rule may be logged for its statistical value.

If rule evaluation service 28 determines at step 410 that a business rule will be violated if the requested database operation is allowed to be performed, then at step 414 rule evaluation service 28 may initiate or perform any number of appropriate actions, either alone or in combination. Rule evaluation service 28 may determine the appropriate action to initiate or perform based on rule information 30 for the one or more violated business rules, including for example the level of enforcement for the one or more violated business rules.

For example, rule evaluation service 28 may return a violation code or other suitable identifier indicating that a violation will occur if the requested database operation is allowed to be performed. In certain embodiments, the violation code may be returned to the stored procedure 24 that communicated the invocation request to rule evaluation service 28. As another example, rule evaluation service 28 may return an explanation for the determined rule violation. In certain embodiments, this explanation may be based on rule information 30 for the violated business rule, including for example the explanatory information regarding the violated business rule. As another example, rule evaluation service 28 may return a violation code or other suitable identifier indicating that the database operation should be denied. As another example, rule evaluation service 28 may return a violation code or other suitable identifier indicating that the database operation should be allowed, but only with special authorization. This authorization may include, for example, the authorization of a manager or other appropriate individual of sufficient authority. As another example, rule evaluation service 28 may return a violation code or other suitable identifier indicating that the database operation should be allowed, but that a process should be initiated to compensate for the consequences of the determined business rule violation. As another example, rule evaluation service 28 may generate or initiate generation of a notification of the business rule violation. The notification may be in any suitable format and may include any suitable information, according to particular needs. The notification may be used to initiate an appropriate action, to support monitoring, or for any other suitable purpose. Although violation of a single rule has been primarily described, a requested database operation could violate multiple rules. In such embodiments, rule evaluation service 28 may return a list of violation codes, the violation code of only the most severe violation, or any other suitable information.

In certain embodiments, rule evaluation service 28 or another suitable component of system 10 may store information regarding determined violations of business rules. For example, rule evaluation service 28 may store information regarding determined violations of business rules in a database or other suitable memory module. The information stored regarding the determined violations of business rules may include an identification of the business rule violated, the number of times the business rule was violated, the explanatory information for the violation (e.g., based on rule information 30 for the violated business rule), the date and time of the violation, the database operation that resulted in the violation, or any other suitable information. The information regarding the determined violations of business rules may be stored if action is delayed as a result of violation of the business rule or at any other suitable time, according to particular needs. The explanatory information regarding the rule may be included in the stored information so that a reviewer of the stored information can identify the business rule and the meaning of the violation of the business rule.

Although particular methods have been described with reference to FIGS. 2-4, the present invention contemplates any suitable methods for in accordance with the present invention. Thus, certain of the steps described with reference to FIGS. 2-4 may take place substantially simultaneously and/or in different orders than as shown and described. Moreover, components of system 10 may use methods with additional steps, fewer steps, and/or different steps, so long as the methods remain appropriate.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system for implementing one or more business rules in an entity, the system comprising one or more computer systems each comprising one or more processing units and one or more memory units, the one or more processing units operable to:
receive a database operation corresponding to one or more database components of one or more operational databases; and
invoke, in response to receiving the database operation, a rule evaluation service operable to:
determine one or more appropriate business rules to evaluate based on the database operation;
evaluate the one or more appropriate business rules to determine whether allowing the database operation to be performed will violate any of the one or more appropriate business rules; and
determine, if it is determined that allowing the database operation to be performed will violate one or more of the evaluated business rules, an appropriate action to initiate for handling the determined violation.

2. The system of claim 1, wherein the database operation comprises one or more of:
a request to add data to one or more operational databases;
a request to modify data in one or more operational databases; and
a request to delete data from one or more operational databases.

3. The system of claim 1, wherein the one or more database components each comprise one or more of:
an operational database;
one or more database tables of an operational database; and
one or more data elements of one or more data tables of the operational database.

4. The system of claim 1, wherein the one or more processing units are operable to execute a stored procedure in response to receiving the database operation, the stored procedure being associated with one of the corresponding database components and operable to invoke the rule evaluation service.

5. The system of claim 4, wherein the one or more processing units are operable to create the stored procedure by mapping a particular business rule to the appropriate database component so that the stored procedure will be executed when a database operation corresponding to the appropriate database component is received.

6. The system of claim 1, wherein the rule evaluation service comprises a rule registry comprising rule information for each business rule, the rule information for a particular business rule comprising one or more of the following:
an algorithm for the particular business rule;
an identification of the one or more database components affected by the particular business rule;
the level of enforcement for the particular business rule; and
explanatory information regarding the particular business rule.

7. The system of claim 6, wherein the rule evaluation service is operable to determine, in response to determining that allowing the database operation to be performed will violate the particular business rule, the appropriate action to initiate for handling the determined violation based on the level of enforcement for the particular business rule.

8. The system of claim 1, wherein the appropriate action comprises one or more of the following:
return a violation code;
return an explanation for the violation of the business rule;
return an indication that the database operation should be allowed, but that special authorization is required;
return an indication that the database operation should be allowed, but that a process should be initiated to compensate for the consequences of the violation; and
communicate a notification of the violation.

9. The system of claim 1, wherein the one or more processing units are operable to deploy a particular one of the one or more appropriate business rules, deploying the particular business rule comprising:
mapping the particular business rule to one or more database components, the particular business rule having been identified for deployment and defined;
creating one or more stored procedures to be executed in response to receiving a database operation corresponding to the one or more database components; and
updating a rule registry of the rule evaluation service with rule information for the particular business rule.

10. The system of claim 9, wherein mapping the particular business rule to the one or more database components comprises:
accessing a virtual database schema for the one or more operational databases; and
determining, using the virtual database schema, the one or more database components for which the particular business rule should evaluated when a database operation corresponding to that database component is received.

11. The system of claim 9, wherein mapping the particular business rule to the one or more database components comprises one or more of:
mapping the particular business rule to a particular operational database;
mapping the particular business rule to one or more database tables of the particular operational database; and
mapping the particular business rule to one or more data elements of one or more database tables of the particular operational database.

12. The system of claim 1, wherein the one or more processing units are further operable to remove a particular one of the one or more appropriate business rules, removing the particular business rule comprising:
determining, in response to identification of the particular business rule for removal, a mapping of the particular business rule to one or more database components; and
updating a rule registry of the rule evaluation service to delete rule information for the particular business rule.

13. The system of claim 12, wherein determining the mapping of the particular business rule to the one or more database components comprises:
accessing a virtual database schema for the one or more operational databases; and
determining, using the virtual database schema, the one or more database components for which the particular business rule should evaluated when a database operation corresponding to that database component is received.

14. The system of claim 1, wherein the one or more processing units are further operable to:
receive the database operation from an application;
return, if it is determined that the database operation will violate one or more of the appropriate business rules, violation information to the application.

15. The system of claim 1, wherein the one or more processing units are further operable to:
deploy a particular one of the one or more business rules for monitoring;
allow the database operation to be performed even if it is determined that the database operation will violate the particular business rule; and
return, if it is determined that the database operation will violate the particular business rules, a notification of the determined violation.

16. The system of claim 1, wherein a particular business rule comprises a rule that defines bounds of acceptable operation of the entity.

17. The system of claim 1, wherein the rule evaluation service is external to the system.

18. A method for implementing one or more business rules in an entity, comprising:
receiving a database operation corresponding to one or more database components of one or more operational databases; and
invoking, in response to receiving the database operation, a rule evaluation service operable to:
determine one or more appropriate business rules to evaluate based on the database operation;
evaluate the one or more appropriate business rules to determine whether allowing the database operation to be performed will violate any of the one or more appropriate business rules; and
determine, if it is determined that allowing the database operation to be performed will violate one or more of the evaluated business rules, an appropriate action to initiate for handling the determined violation.

19. The method of claim 18, wherein the database operation comprises one or more of:
a request to add data to one or more operational databases;
a request to modify data in one or more operational databases; and
a request to delete data from one or more operational databases.

20. The method of claim 18, wherein the one or more database components each comprise one or more of:
an operational database;
one or more database tables of an operational database; and
one or more data elements of one or more data tables of the operational database.

21. The method of claim 18, comprising executing a stored procedure in response to receiving the database operation, the stored procedure being associated with one of the corresponding database components and operable to invoke the rule evaluation service.

22. The method of claim 21, comprising creating the stored procedure by mapping a particular business rule to the appropriate database component so that the stored procedure will be executed when a database operation corresponding to the appropriate database component is received.

23. The method of claim 18, wherein the rule evaluation service comprises a rule registry comprising rule information for each business rule, the rule information for a particular business rule comprising one or more of the following:
an algorithm for the particular business rule;
an identification of the one or more database components affected by the particular business rule;
the level of enforcement for the particular business rule; and
explanatory information regarding the particular business rule.

24. The method of claim 23, comprising determining, in response to determining that allowing the database operation to be performed will violate the particular business rule, the appropriate action to initiate for handling the determined violation based on the level of enforcement for the particular business rule.

25. The method of claim 18, wherein the appropriate action comprises one or more of the following:
returning a violation code;
returning an explanation for the violation of the business rule;
returning an indication that the database operation should be allowed, but that special authorization is required;
returning an indication that the database operation should be allowed, but that a process should be initiated to compensate for the consequences of the violation; and
communicating a notification of the violation.

26. The method of claim 18, comprising deploying a particular one of the one or more appropriate business rules, deploying the particular business rule comprising:
mapping the particular business rule to one or more database components, the particular business rule having been identified for deployment and defined;
creating one or more stored procedures to be executed in response to receiving a database operation corresponding to the one or more database components; and
updating a rule registry of the rule evaluation service with rule information for the particular business rule.

27. The method of claim 26, wherein mapping the particular business rule to the one or more database components comprises:
accessing a virtual database schema for the one or more operational databases; and
determining, using the virtual database schema, the one or more database components for which the particular business rule should evaluated when a database operation corresponding to that database component is received.

28. The method of claim 26, wherein mapping the particular business rule to the one or more database components comprises one or more of:
mapping the particular business rule to a particular operational database;
mapping the particular business rule to one or more database tables of the particular operational database; and
mapping the particular business rule to one or more data elements of one or more database tables of the particular operational database.

29. The method of claim 18, further comprising removing a particular one of the one or more appropriate business rules, removing the particular business rule comprising:
determining, in response to identification of the particular business rule for removal, a mapping of the particular business rule to one or more database components; and
updating a rule registry of the rule evaluation service to delete rule information for the particular business rule.

30. The method of claim 29, wherein determining the mapping of the particular business rule to the one or more database components comprises:
accessing a virtual database schema for the one or more operational databases; and
determining, using the virtual database schema, the one or more database components for which the particular business rule should evaluated when a database operation corresponding to that database component is received.

31. The method of claim 18, further comprising:
receiving the database operation from an application;
returning, if it is determined that the database operation will violate one or more of the appropriate business rules, violation information to the application.

32. The method of claim 18, further comprising:
deploying a particular one of the one or more business rules for monitoring;
allowing the database operation to be performed even if it is determined that the database operation will violate the particular business rule; and
returning, if it is determined that the database operation will violate the particular business rules, a notification of the determined violation.

33. The method of claim 18, wherein a particular business rule comprises a rule that defines bounds of acceptable operation of the entity.

34. Software for implementing one or more business rules in an entity, the software being embodied in a computer-readable medium and when executed operable to:
receive a database operation corresponding to one or more database components of one or more operational databases; and
invoke, in response to receiving the database operation, a rule evaluation service operable to:
determine one or more appropriate business rules to evaluate based on the database operation;
evaluate the one or more appropriate business rules to determine whether allowing the database operation to be performed will violate any of the one or more appropriate business rules; and
determine, if it is determined that allowing the database operation to be performed will violate one or more of the evaluated business rules, an appropriate action to initiate for handling the determined violation.

35. The software of claim 34, wherein the database operation comprises one or more of:
a request to add data to one or more operational databases;
a request to modify data in one or more operational databases; and
a request to delete data from one or more operational databases.

36. The software of claim 34, wherein the one or more database components each comprise one or more of:
an operational database;
one or more database tables of an operational database; and
one or more data elements of one or more data tables of the operational database.

37. The software of claim 34, operable to execute a stored procedure in response to receiving the database operation, the stored procedure being associated with one of the corresponding database components and operable to invoke the rule evaluation service.

38. The software of claim 37, operable to create the stored procedure by mapping a particular business rule to the appropriate database component so that the stored procedure will be executed when a database operation corresponding to the appropriate database component is received.

39. The software of claim 34, wherein the rule evaluation service comprises a rule registry comprising rule information for each business rule, the rule information for a particular business rule comprising one or more of the following:
an algorithm for the particular business rule;
an identification of the one or more database components affected by the particular business rule;
the level of enforcement for the particular business rule; and
explanatory information regarding the particular business rule.

40. The software of claim 39, operable to determine, in response to determining that allowing the database operation to be performed will violate the particular business rule, the appropriate action to initiate for handling the determined violation based on the level of enforcement for the particular business rule.

41. The software of claim 34, wherein the appropriate action comprises one or more of the following:
returning a violation code;
returning an explanation for the violation of the business rule;
returning an indication that the database operation should be allowed, but that special authorization is required;
returning an indication that the database operation should be allowed, but that a process should be initiated to compensate for the consequences of the violation; and
communicating a notification of the violation.

42. The software of claim 34, operable to deploy a particular one of the one or more appropriate business rules, deploying the particular business rule comprising:
mapping the particular business rule to one or more database components, the particular business rule having been identified for deployment and defined;
creating one or more stored procedures to be executed in response to receiving a database operation corresponding to the one or more database components; and
updating a rule registry of the rule evaluation service with rule information for the particular business rule.

43. The software of claim 42, wherein mapping the particular business rule to the one or more database components comprises:
accessing a virtual database schema for the one or more operational databases; and
determining, using the virtual database schema, the one or more database components for which the particular business rule should evaluated when a database operation corresponding to that database component is received.

44. The software of claim 42, wherein mapping the particular business rule to the one or more database components comprises one or more of:
mapping the particular business rule to a particular operational database;
mapping the particular business rule to one or more database tables of the particular operational database; and
mapping the particular business rule to one or more data elements of one or more database tables of the particular operational database.

45. The software of claim 34, further operable to remove a particular one of the one or more appropriate business rules, removing the particular business rule comprising:
determining, in response to identification of the particular business rule for removal, a mapping of the particular business rule to one or more database components; and
updating a rule registry of the rule evaluation service to delete rule information for the particular business rule.

46. The software of claim 45, wherein determining the mapping of the particular business rule to the one or more database components comprises:
accessing a virtual database schema for the one or more operational databases; and
determining, using the virtual database schema, the one or more database components for which the particular business rule should evaluated when a database operation corresponding to that database component is received.

47. The software of claim 34, further operable to:
receive the database operation from an application;
return, if it is determined that the database operation will violate one or more of the appropriate business rules, violation information to the application.

48. The software of claim 34, further operable to:
deploy a particular one of the one or more business rules for monitoring;
allow the database operation to be performed even if it is determined that the database operation will violate the particular business rule; and
return, if it is determined that the database operation will violate the particular business rules, a notification of the determined violation.

49. The software of claim 34, wherein a particular business rule comprises a rule that defines bounds of acceptable operation of the entity.
